(19) United States
(12) Patent Application Publication
(10) Pub. No.: US 2008/0185802 A1
(43) Pub. Date: Aug. 7, 2008

(54) Cart

(76) Inventor: Wayne David Fleming, Ponchatoula, LA (US)

Correspondence Address: KEATY PROFESSIONAL LAW CORPORATION;THOMAS S. KEATY, 2 CANAL STREET, 2140 WORLD TRADE CENTER, NEW ORLEANS, LA, 70130, US

(21) Appl. No.: 11/703,468

(22) Filed: Feb. 7, 2007

(51) Int. Cl. B62B 1/12

(52) U.S. Cl. 280/47.18

(57) ABSTRACT

The invenition relates to a wheeled cart assembly for transporting a variety of items for an outdoor activity. The cart bed carries one or more compartments for accommodating different shaped items, such as an upright rack, a water bucket and the like. The upright rack cani come as an optional accessory; it can be designed to hold toys, gardening implements, cup holders, and other hand held items . A recessed compartment formed in the cart bed stabilizes a water bucket when transported by the cart assembly.

### BACKGROUND OF THE INVENTION

This invention relates to organization of accessories, and more particularly, to a multitask cart for transporting hand tools, garden implements, toys and other items used in recreational and gardening activities.

When working or playing outdoors. people usually use a variety of tools, implements, and devices that allow easy access to most frequently used items. For instance, When gardening, a person may use hand tools, watering cans, buckets, gloves and the like. When engaged in a recreational activity outdoors, the person may desire to have easy access to liquid beverages, coolers, and other such items that would allow the user to stay outdoors in a desired location without having to return to the car or indoors to retrieve beverages or food. Similarly, children playing outdoors need a cart or wagon to transport their toys, toy garden tools. insect collection tools. and other sSuch items that would be of use outdoors.

To assist individuals in carrying these items, the industry has developed a number Of solutions. One such solution is provision of a trolley or cart. which has a generally rectangular bed defined by a flat bottom and vertically extending peripheral walls. The trolley may be mounted on wheels to facilitate transportation of the cart to the desired location. The user may position the needed instruments onto the trolley bed and transport the trollev or cart by pulling or pushing the cart by a handle attached to the cart bed. [0004] Another solution is to provide a cooler with a pair of wheels and a retractable handle allowing the user to pull the cooler to the desired location and have access to the cool beverages or food at the picnic site or in a job location. A conventional “red wagon” is also used for transporting various items. If necessary, the user places the items on the wagon bed and pulls the wagon to the desired location of the outdoor activity. However, if a user needs to transport a bucket with water using a flat bed of a “red wagon”, there is a possibility that the bucket bottom will slide in the bed and spill the liquid from the bucket.

The present invention contemplates elimination or drawtbacks associated with conventional solutions and provision of an organizing cart assembly with various compartments and accessories for accommodating tools, liquid containers, and the like.

### SUMMARY OF THE INVENTION

It is, therefore, an object of the present invention to provide an organizing cart or wagon that is adapted for transporting various items in an outdoor environment.

It is another object of the present invention to provide a wagon with interchangeable tool holders for transportation of various items to a desired location.

These and other objects of the present invention are achieved through a provision of an organizing cart assembly that allows transportation of a variety of items to an outdoor location. The assembly has a cart bed mounted on rotating wheels and one or more accessories, such as an upright rack for holding various hand-held tools or toys on the cart. The cart bed has a plurality of compartments for accommodating the rack, small items, water bucket and the like. A water bucket can be placed in a recessed compartment formed in the cart bed and the cutout made in the upper plate of the cart bed retains the bucket in a stable position.

A compartment placed near a rear portion of the cart bed is provided with an insert to accommodate a bottom end of an upright rack and support the rack on the cart. The upright rack can be provided as an optional accessory for the wheeled cart. The upright rack has a transverse arm that is capable of holding a variety of hand-held items, such as toy garden tools. insect catching tools, gardening implements and the like. Aln alternative of the upright rack transverse arm can be provided with cup holders.

An upright shoulder formed by the upper plate and the vertical sidewalls facilitates a stable position of items placed on the upper plate of the cart bed. When the cart bed is tilted during transportation, an object placed on the cart bed can lean against the upright shoulder without sliding along the bed.

### BRIEF DESCRIPTION OF THE DRAWING

Reference will now be made to the drawings, wherein like parts are designated by like numerals, and wherein

FIG. 1 is a perspective view of the cart in accordance with the present invention.

FIG. 2 is a detail view of an upright rack accessory with various hand tools retained on the rack's transverse member.

FIG. 3 is a perspective view illustrating the upright rack and bucket accessories of the assembly of the present invention.

FIG. 4 is a perspective view of a second embodiment of the rack accessories particularly adapted for holding cups.

FIG. 5 is a perspective view of the cart assembly of the present invenition shown with the uprightt rack accessory of the second embodiment.

FIG. 6. is a perspective view of the cart assembly of the present invention shown with the upright rack accessory of the first embodiment.

### DETAILED DESCRIPTION OF THE INVENTION

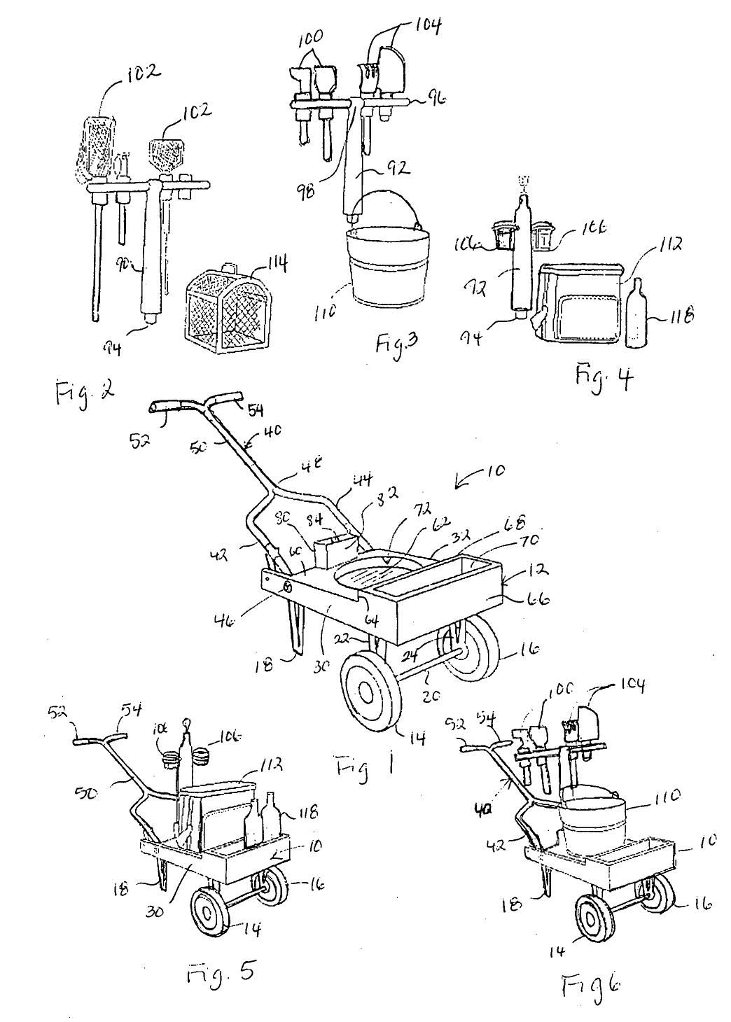

Turning now to the drawings in more detail. numeral 10 designates the organizational cart in accordance with the present invention. As can be seen in the drawings the cart 10 comprises a cart bed 12 mounted on rotating wheels, 14, 16, and a fixed support 18. The wheels 14 and 16 are connected by a common axle 20, the wheels 14 and 16 rotating in unison when the cart 10 is pulled or pushed along the ground. A supporting bracket 22 secured to the bottom of the cart bed 12 engages one end of the axle 20 while the second bracket 24 engages the opposite side of the axle 20. The brackets 22 and 24 are fixedly secured to the bottom of the cart bed 12 in a spaced apart generally parallel, opposing relationship. The support 18 can be a fixed rod or a V-shaped member shown in FIGS. 1, 5, and 6, which is affixed to the bottom of the cart bed 12 centrally between opposing side walls 30, 32 of the cart bed 12.

A handle 40 secured to the cart bed 12 is provided with opposing arms 42, 44 pivotally engaged with respective pivot pins 46 (only one shown in the drawings) to the sidewalls 30 and 32 of the cart bed 12. The arms 42 and 44 converge at a point 48 and an elongated handle member 50 extends from the point of convergence 48 to a pair of gripping members 52, 54. The gripping members may be provided with non-slipping exterior surface, if desired to facilitate easy maneuvering of the cart 10.

The cart bed 12 comprises a flat upper plate 60 and a bottom plate 62. The sidewalls 30 and 32 extend upwardly from the bottom plate 62 to the upper plate 60. The sidewalls 30 and 32 have extended height in the front portion adjacent the wheels 14 and 16 forming a step shoulder 64. A front wall 66 is fixedly secured between the walls 30 and 32. and a vertical wall 68 is secured to the shoulders 64 transversely to the longitudinal extension of the sidewalls 30 and 32. The walls 30, 32, 66, and 68 define a first compartment 70 in the front portion of the cart bed 12.

A recess 72 formed in the upper plate 60 defines a second compartment between the plates 60 and 62. The second compartment 72 has a generally circular configuration to accommodate a bucket or other items having a circular exterior surface and securely retain the item within the second compartment 72.

A third compartment 80 is formed adjacent a rear portion of the cart bed 12. The rack-supporting compartment 80 is fixedly attached to the top plate 60 of the cart bed 12. The rack-supporting compartment 80 is defined by upwardly extending walls 82 which can form a rectangular compartment or a circular compartment if desired. An tubular insert 84 is positioned in the compartment 80 to accommodate a lower end of a rack accessory, as will be described hereinafter.

An upright tool rack accessory 90 is provided as an accessory to the cart bed 12. The tool rack 90 comprises an upright member 92 having a reduced diameter bottom end 94 that is dimensioned to fit within the insert 84 and engage frictionally therein. A transverse member, or arm 96 is engaged within a sleeve formed by an upper part 98 of the upright support 92. The transverse support arm 96 can be interchanged to accommodate various types of hand tools or implements transported by the cart bed 12. For instance, the transverse arm 96 can have holders for retaining toy garden tools, generally designated by numeral 100 in FIG. 3, insect catching devices generally designated by numeral 102 in FIG. 2. or full size gardening tools generally designated by numeral 104 in FIG. 6. Alternatively, the upright support 92 may be provided with circular cup holders 106 shown in FIGS. 4 and 5 if desired. The upright support shown in FIGS. 4 and 5 is also provided with a reduced diameter bottom part 94 that is configured to frictionally engage withlini the insert 84 of the rack support 80.

In operation, the user positions the upright member 90 such that the bottom part 94 fits within the insert 84 and then positions the desired instruments and tools within the retaining members on the transverse arm 96. If desired, the transverse member 90 may have cup holders 106 shown in FIGS. 4 and 5. The second compartment 72 can be used to accommodate a bucket 110 shown in FIGS. 3 and 6, allowing transportation of the water, if necessary, to a desired location. Thee flat bed as defined by the top plate 60 can also be used for supporting a cooler 112 shown in FIGS. 4 and 5 or an insect trap device 114, as shown in FIG. 2. Rectangular items, such as the cooler 112 and the insect trap 114 can be placed in the center of the cart bed 12, leaning against the upright wall 68 and the shoulders 64, which facilitates a stable position of the cooler 112 or the insect trap 114 on the cart bed 12.

The first compartment 70 can be used to accommodate gloves. suntan lotion, small gardening items, or beverage bottles 118, as shown in FIGS. 4 and 5.

The organizing cart assembly 10 of the present invention can be made from any number of materials, including wood, plastic, metal, and the like. It is preferred that the material be rust free to insure extended life of the cart.

The support racks 90 can be provided as optional accessories for the cart bed 12 with numerous tool holders that can be interchanged for use with the upright member 92. The dimensions of the compartment 70, 72 and 80 can be modified to accommodate any number of items specifically adapted for outdoor activities. If desired, the visible surfaces of the cart bed 12 can be decorated with attractive drawings and decorative designs to make the cart 10 more entertaining for the children.

Many other changes and modifications can be made in the design of the present invention without departing from the spirit thereof. I, therefore, pray that my rights to the present invention be limited only by the scope of the appended claims.

I claim:

1 An organizing cart assembly, comprisiing:
a cart bed structure having a forward portion and a rear portion;
a plurality of compartments formed on said cart bed structure; and
a handle means secured at the rear portion for controlling movement of the cart upon demand.

2. The apparatus of claim 1, further comprising a pair of spaced rotating wheels mounted at the front portion of the cart structure.

3 The apparatus of claim 1, wherein said handle means is pivotally secured to said cart bed structure.

4. The apparatus of claim 3, wherein said plurality of compartments comprises a first compartment formed at the front portion of the cart bed structure, a second compartment formed between the front portion and the rear portion, and a third compartment mounted at the rear portion of the compartment.

5. The apparatus of claim 4, further comprising a hollow container configured for removably positioning in said second compartment.

6. The apparatus of claim 4, further comprising an upright rack capable of being detachably positioned on said cart bed structure.

7. The apparatus of claim 6 wherein said upright reek comprises an upright member having a recduced size lower portion.

8. The apparatus of claim 7, wherein said third compartment has vertically extending walls and an insert, said insert being capable of detachably receiving the lower portion of said upright member.

9. The apparatus of claim 7, wherein said upright rack further comprises a transverse holder detachably secured to said upright member, said transverse holder configured for holding one or more hand-held tools and auxiliary items.

10. The apparatus of claim 7, wherein said upright rack further comprises a transverse holder detachably secured to said upright member, said transverse holder configured for holding one or more cup holders.

11. The apparatus of claim 4, wherein said cart bed structure comprises a bottom plate and a spaced-apart upper plate

12. The apparatus of claim 11, wherein said upper plate defines an upwardly extending shoulder extending transversely between opposing side wails of the cart bed structure, said shoulder defining a rear wall of the first compartment.

13. The apparatus of claim 11, wherein said second compartment is formed between the upper plate and the bottom plate.

14. The apparatus for claim 11, further comprising a rear support member fixedly secured to and extending downwardly from a real-portion of said bottom plate.

15. An organizing cart assembly, comprising:
a cart bed structure having a forward portion and a rear portion, an upper plate and a spaced apart bottom plate;
a first compartment formed at the forward portion of the cart bed structure, a second compartment formed between the upper plate and the bottom plate, and a third compartment formed at the rear portion of the cart bed structure.
a handle means secured at the rear portion for controlling movement of the cart upon demand; and an upright rack detachably positionable in said third compartment said upright rack being capable of retaining one or more hand-held items.

16. Thle apparatus of claim 15,. wherein a retaining insert is mounted in said third compartment, and wherein a lower part of said upright rack frictionally engages with said insert.

17. The apparatus of claim 15 wherein said upright rack comprises an upright member and a transverse holder detachably secured to said uptight member, said transverse holder being capable of retaining one or more hand-held items thereon.

18. The apparatus of claim 15, wherein said upper plate comprises an upright shoulder extending transversely between the first compartment and the second compartment.

19. The apparatus of claim 15, further comprisinig a hollow container detachably positionable in said second container.

20. The apparatus of claim 15, wherein a pair of spaced opposing brackets is secured to the bottom plate, and wherein each ot said brackets carries a rotating wheel.

21. The apparatus for claim 15, further comprising a rear support member fixedly secured to and extending downwardly from a rear portion of said bottom plate.
